(19) United States
(12) Patent Application Publication
(10) Pub. No.: US 2008/0235599 A1
(43) Pub. Date: Sep. 25, 2008

(54) CONTENT SHARING VIA DISCOVERY OF AND TRANSFER TO NEARBY MORE CAPABLE DEVICES

(75) Inventors: Steve Emmert, Crystal Lake, IL (US); Zili Li, Barrington, IL (US)

Correspondence Address: PRASS & IRVING LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/688,197

(22) Filed: Mar. 19, 2007

(51) Int. Cl. G06F 3/00

(52) U.S. Cl. 715/748

(57) ABSTRACT

A method, mobile telecommunications apparatus, and electronic device for optimally presenting media content are disclosed. A memory stores the media content. A processor identifies a media type for the media content and identifies capable media devices among proximate media devices. An interface transfers the media content to a selected media device.

### FIELD OF THE INVENTION

The present invention relates to a method and system for optimizing content presentation. The present invention further relates to identifying the optimum presentation device and transferring content to that device.

### INTRODUCTION

Modern mobile telecommunications devices, such as cellular telephones, may download a variety of media content. This media content may include such media types as text, images, audio, video, and other types of media. The media content may be any of a variety of formats, such as standards provided by Moving Picture Experts Group (MPEG) (Including MPEG 1, Layer 3 (MP3)), standards provided by Joint Photographic Experts Group (JPEG), Portable Document Format (PDF), and others.

While cellular telephones are convenient devices for receiving and storing this media content, they are not always the best devices for displaying the media content. The small display screens for the cellular telephones do not allow for the full enjoyment of a video or image or allow for the easy reading of text due to its limited display resolution. In addition the small screen limits its ability to share the display content. The speaker system of a cellular telephone, while ideal for the one-on-one conversation of a telephone, is less suitable for playing audio files for more than one person. What is needed is a method of combining the portability of media content data files provided by cellular telephones while still providing an optimum showcase for that media content.

### SUMMARY OF THE INVENTION

A method, mobile telecommunications apparatus, and electronic device for optimally presenting media content are disclosed. A memory stores the media content. A processor identifies a media type for the media content and identifies capable media devices among proximate media devices. An interface transfers the media content to a selected media device.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates in a block diagram one embodiment of a network of proximate presentation devices, which may be used by the present invention.

FIG. 2 illustrates in a flowchart one embodiment of a method for an optimized presentation of media.

FIG. 3 illustrates in a flowchart an alternate embodiment of a method for an optimized presentation of media.

FIG. 4 illustrates a possible configuration of a computing system to act as a mobile telecommunications apparatus or electronic device to execute the present invention.

FIG. 5 illustrates in a block diagram one embodiment of a mobile telephone that may implement the present invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, an apparatus, and an electronic device, and other embodiments that relate to the basic concepts of the invention. The electronic device may be any manner of computer, mobile device, or wireless communication device.

A method, mobile telecommunications apparatus, and electronic device for optimally presenting media content are disclosed. A memory stores the media content. A processor identifies a media type for the media content and identifies capable media devices among proximate media devices. An interface transfers the media content to a selected media device.

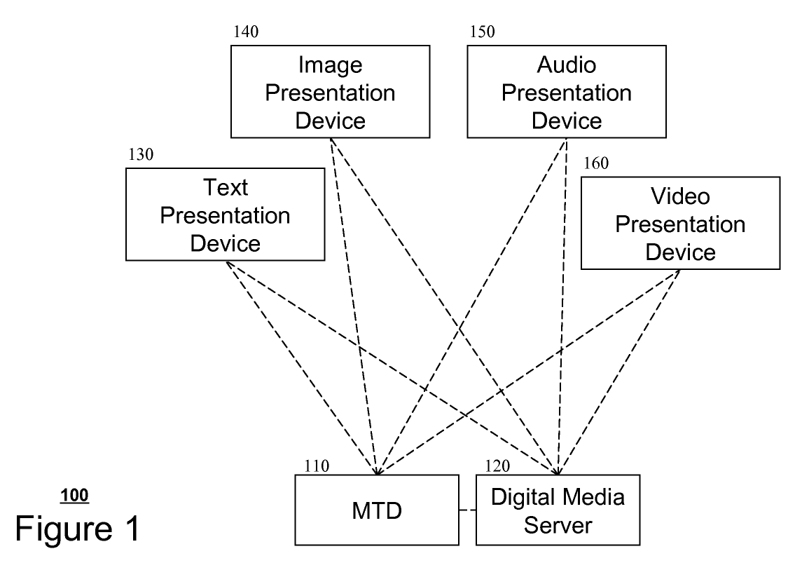

FIG. 1 illustrates in a block diagram one embodiment a network 100 of proximate presentation devices, which may be used by the present invention. A mobile telecommunications device (MTD) 110 is a mobile apparatus or electronic device that may perform a telecommunications function, such as a cellular telephone, laptop computer, or other communications device. The MTD 110 may download media content from a media source, such as a website, or have media content loaded onto it via a removable data storage medium or transmitted through varieties of wireless communication networks. The media content may be text, image, audio, video, or some other form of media. The media may be in any number of formats, such as standards provided by Moving Picture Experts Group (MPEG) (Including MPEG 1, Layer 3 (MP3)), standards provided by Joint Photographic Experts Group (JPEG), Portable Document Format (PDF), and other standards.

The MTD 110 may identify any number of media devices (MDs) for displaying many different types of media. The MTD 110 may limit identified MDs to a proximate area. The proximate area may be determined based upon a specific distance from the location of the MTD 110, or based upon the effective radio range of the MTD 110. The MTD 110 may identify as a MD a digital media server 120. A digital media server may deliver the media content, either wired or wirelessly, to a variety of media presentation devices that may then proceed to present the media. Alternatively, the MTD 110 may deliver the media content directly to the MDs without using a digital media server 120. The MD may be a text presentation device 120, such as a data terminal, desktop computer, or other device ideal for the presentation of text. The MD may be an image presentation device 130, such as a digital slide projector, adjustable image display, or other device ideal for the presentation of images. The MD may be an audio presentation device 140, such as a digital radio, stereo system or other device ideal for the presentation of audio. The MD may be a video presentation device 150, such as a digital projector, high definition television (HDTV), or other device ideal for the presentation of video.

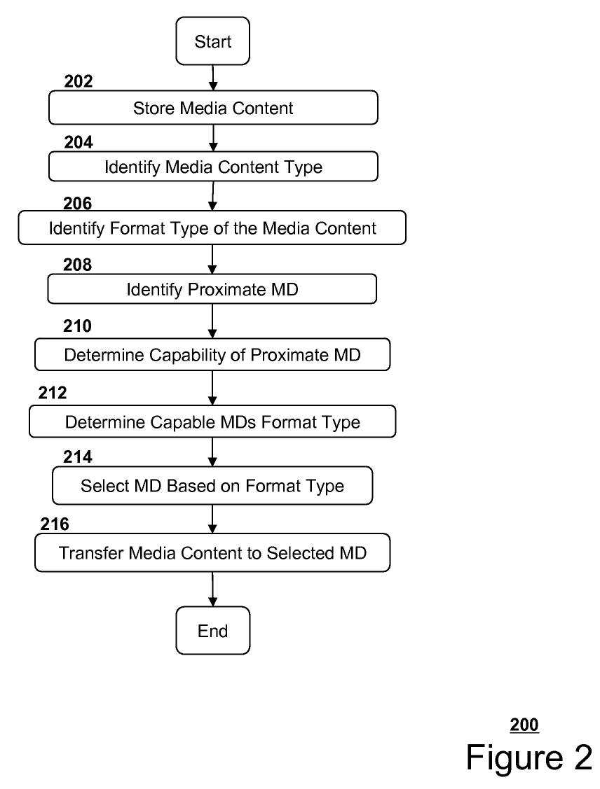

FIG. 2 illustrates in a flowchart one embodiment of a method 200 for an optimized presentation of media. The MTD 110 may store the media content (Block 202). Alternatively, the MTD 110 may download the media content and transfer it to the MDs directly without storing. The MTD 110 may identify the media type of the media content, such as video, audio, or other (Block 204). The MTD 110 may identify the format type of the media content, such as MPEG, MP3, JPEG, or other (Block 206). The MTD 110 may identify any MDs in the proximate area (Block 208). The MTD 110 may determine whether the proximate MDs are capable of presenting the media content (Block 210). The MTD 110 may determine the format type of each of the capable MDs (Block 212). The MTD 110 may select a capable MD based on the format type of the MD (Block 214). For example, the MD may be selected because it uses a format type that is the same as or is a type easily convertible from the format type of the media content. The MTD may then transfer the media content to the selected MD (Block 216). The media content may be transferred via a wireless local area network (WLAN), Bluetooth®, or other data transfer means.

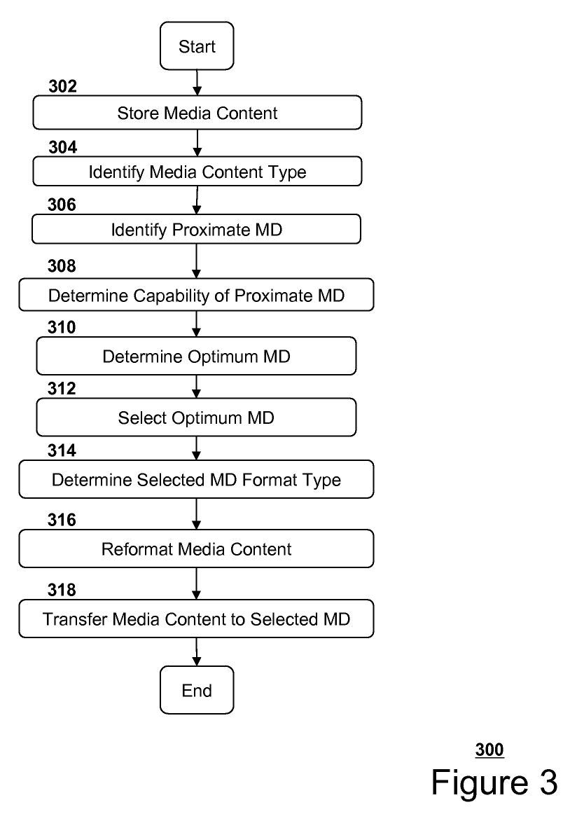

FIG. 3 illustrates in a flowchart an alternate embodiment of a method 300 for an optimized presentation of media. The MTD 110 may store the media content (Block 302). The MTD 110 may identify the media type of the media content, such as video, audio, or other (Block 304). The MTD 110 may identify any MDs in the proximate area (Block 306). The MTD 110 may determine whether the proximate MDs are capable of presenting the media content (Block 308). The MTD 110 may determine the optimum media devices for presenting the media content from among the capable media devices (Block 312). The optimum MD may be determined by presenting the available options to a user who may then select the best MD. The MTD 110 may automatically select an optimum MD using a predetermined set of criteria, either a default set of criteria or a set of criteria determined by the user. The criteria may include pixel count, screen size, audio quality, format compatibility, or types of criteria. The MTD 110 may select the optimum MD (Block 312). The MTD 110 may determine the format type of each of the selected MD, such as MPEG, MP3, JPEG, or other (Block 314). The MTD 110 may reformat the media content to match the format of the MD if the formats differ (Block 316). The MTD may then transfer the media content to the selected MD (Block 318).

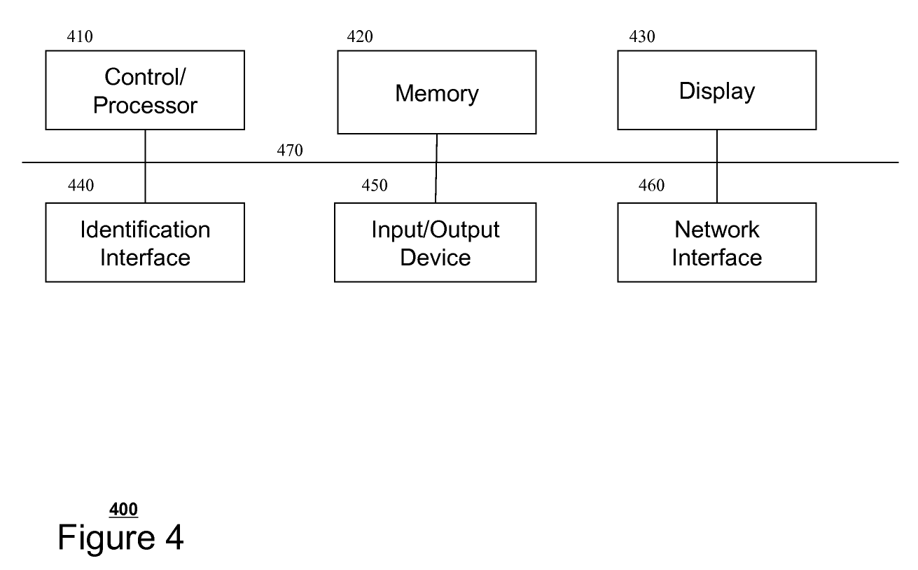

FIG. 4 illustrates a possible configuration of a computing system 400 to act as a mobile telecommunications apparatus or electronic device to execute the present invention. The computer system 400 may include a controller/processor 410, a memory 420, display 430, identification interface 440, input/output device interface 450, and a network interface 460, connected through a bus 470. The computer system 400 may implement any operating system, such as Windows or UNIX, for example. Client and server software may be written in any programming language, such as ABAP, C, C++, Java, or Visual Basic, for example.

The controller/processor 410 may be any programmed processor known to one of skill in the art. However, the decision support method can also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The memory 420 may include volatile and nonvolatile data storage, including one or more electrical, magnetic or optical memories such as a random access memory (RAM), cache, hard drive, or other memory device. The memory may have a cache to speed access to specific data. The memory 420 may also be connected to a compact disc-read only memory (CD-ROM), digital video disc-read only memory (DVD-ROM), DVD read write input, tape drive, flash memory, or other removable memory device that allows media content to be directly uploaded into the system.

The identification interface 440 allows the MTD 110 to connect to an identification network. The identification network allows the various MDs to identify themselves to the MTD 110. One example of an identification network would be radio frequency identification (RFID) devices installed in the MDs. The RFID identifiers would transmit to the MTD 110 the presence and capability of a proximate MD.

The Input/Output interface 450 may be connected to one or more input devices that may include a keyboard, mouse, pen-operated touch screen or monitor, voice-recognition device, or any other device that accepts input. The Input/Output interface 450 may also be connected to one or more output devices, such as a monitor, printer, disk drive, speakers, or any other device provided to output data.

The network interface 460 may be connected to a communication device, modem, network interface card, a transceiver, or any other device capable of transmitting and receiving signals over a network. The network interface 460 may be used to transmit the media content to the selected media device. The network interface may also be used to download the media content from a media source, such as a website or other media sources. The network interface 460 may also be used to communicate between the MTD 110 and the different proximate MDs, allowing the MDs to identify themselves to the MTD 110 if the MD lacks an RFID identifier or if the MTD 110 lacks an identification interface 440. The components of the computer system 400 may be connected via an electrical bus 470, for example, or linked wirelessly.

Client software and databases may be accessed by the controller/processor 410 from memory 420, and may include, for example, database applications, word processing applications, the client side of a client/server application such as a billing system, as well as components that embody the decision support functionality of the present invention. The user access data may be stored in either a database accessible through the database interface 440 or in the memory 420. The computer system 400 may implement any operating system, such as Windows or UNIX, for example. Client and server software may be written in any programming language, such as ABAP, C, C++, Java or Visual Basic, for example.

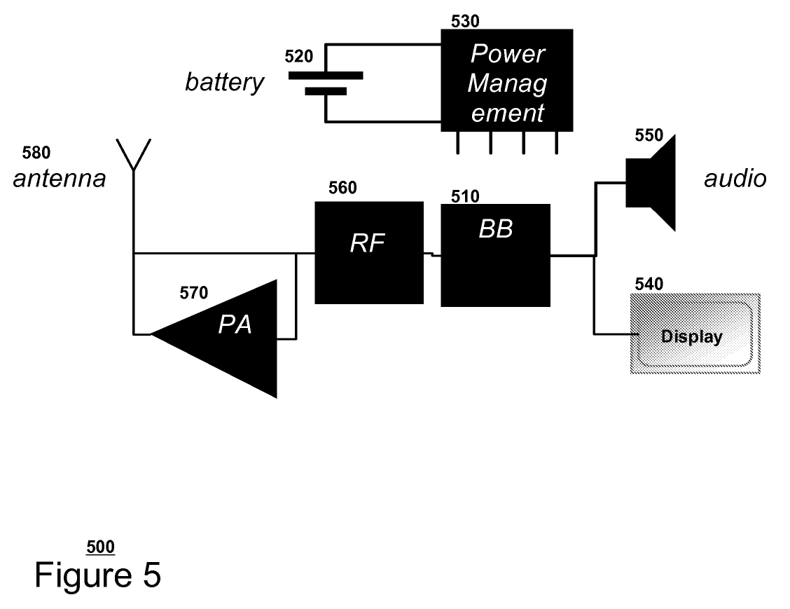

FIG. 5 illustrates in a block diagram one embodiment of a mobile telephone 500 that may implement the present invention. The base-band (BB) processor 510 may execute many of the functions of the processor 410 and the memory 420. A battery 520 managed by a power management circuit 530 may power the mobile telephone 500. Any media stored on the mobile telephone 500 may be presented using a display 540 for video and a speaker 550 for audio. A radio frequency (RF) circuit 560 may convert a message to a RF signal. An amplifier circuit 570 amplifies the signal and transmits the signal over the antenna 580.

Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof through a communications network.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the electronic devices each processing the content in various possible ways. It does not necessarily need to be one system used by all end users. Accordingly, the appended claims and their legal equivalents should only define the invention, rather than any specific examples given.

We claim:

1. A method for presenting media content, comprising:
identifying a media type for media content in a mobile telecommunications apparatus;
identifying capable media devices for that media type; and
transferring the media content to a selected media device.

2. The method of claim 1, further comprising determining a format type for the selected media device.

3. The method of claim 2, further comprising reformatting the media content for the selected media device.

4. The method of claim 2, further comprising selecting the selected media device based on the format type.

5. The method of claim 1, wherein capable media devices are identified using radio frequency identification devices.

6. The method of claim 1, wherein media type is one of video, audio, image, or text.

7. The method of claim 1, further comprising:
determining an optimum media device to present the media content; and
selecting the optimum media device to present the media content.

8. A mobile telecommunications apparatus that receives media content, comprising:
a processor that identifies a media type for the media content and identifies capable media devices among proximate media devices; and
an interface that transfers the media content to a selected media device.

9. The mobile telecommunications apparatus of claim 8, wherein the processor determines a format type for the selected media device.

10. The mobile telecommunications apparatus of claim 9, wherein the processor reformats the media content for the selected media device.

11. The mobile telecommunications apparatus of claim 9, wherein the processor selects the selected media device based on the format type.

12. The mobile telecommunications apparatus of claim 8, further comprising an automatic identification interface to identify proximate media devices.

13. The mobile telecommunications apparatus of claim 8, wherein media type is one of video, audio, image, or text.

14. The mobile telecommunications apparatus of claim 8, wherein the processor determines an optimum media device to present the media content and selects the optimum media device to present the media content.

15. An electronic device that receives media content, comprising:
a processor that identifies a media type for the media content and identifies capable media devices among proximate media devices; and
an interface that transfers the media content to a selected media device.

16. The electronic device of claim 15, wherein the processor determines a format type for the selected media device.

17. The electronic device of claim 16, wherein the processor reformats the media content for the selected media device.

18. The electronic device of claim 16, wherein the processor selects the selected media device based on the format type.

19. The electronic device of claim 15, further comprising an automatic identification interface to identify proximate media devices.

20. The electronic device of claim 15, wherein the processor determines an optimum media device to present the media content and selects the optimum media device to present the media content.
